(19) United States
(12) Patent Application Publication
(10) Pub. No.: US 2024/0312178 A1
(43) Pub. Date: Sep. 19, 2024

(54) TARGET MONITORING DEVICE, TARGET MONITORING METHOD, AND RECORDING MEDIUM

(71) Applicant: FURUNO ELECTRIC CO., LTD., Hyogo (JP)

(72) Inventors: Katsuyuki YANAGI, Hyogo (JP); Yuta TAKAHASHI, Hyogo (JP)

(73) Assignee: FURUNO ELECTRIC CO., LTD., Hyogo (JP)

(21) Appl. No.: 18/677,863

(22) Filed: May 29, 2024

Related U.S. Application Data
(63) Continuation of application No. PCT/JP2022/013014, filed on Mar. 22, 2022.

(30) Foreign Application Priority Data
Dec. 16, 2021 (JP) 2021-203918

(51) Int. Cl. G06V 10/70; H04N 23/69; H04N 23/695

(52) U.S. Cl. CPC G06V 10/70; H04N 23/69; H04N 23/695; G06V 2201/07

(57) ABSTRACT

A target monitoring device includes processing circuitry configured to: sequentially acquire an image including a marine view captured by a camera during a panning operation; detect a target included in the image; determine whether or not the detected target is identical to a target registered in a database in which target data of a target detected by a target detection unit different from the camera is registered; and stop the panning operation of the camera with the detected target included in an angle of view, when the detected target is not the target registered in the database.

### CROSS-REFERENCE TO RELATED APPLICATION

This application is a continuation of PCT International Application No. PCT/JP2022/013014, filed on Mar. 22, 2022, which claims priority under 35 U. S. C § 119(a) to Japanese Patent Application No. 2021-203918, filed on Dec. 16, 2021. Each of the above application(s) is hereby expressly incorporated by reference, in its entity, into the present application.

### BACKGROUND

### Technical Field

The disclosure relates to a target monitoring device, a target monitoring method, and a non-transitory computer-readable recording medium, recording a control program.

### Related Art

Patent Document 1 discloses a technique for linking and combining information obtained by a device or apparatus such as a radar with information obtained from a camera image.

### CITATION LIST

### Patent Literature

[Patent Literature 1] JP 6236549

However, radars may cause false detection due to sea surface reflections, false image echoes, and the like. Further, AIS cannot detect ships that are not equipped with or do not use AIS, or targets other than ships.

The disclosure has been made in view of the above problems, and the purpose of this disclosure relates to a target monitoring device, a target monitoring method, and a non-transitory computer-readable recording medium, recording a control program that facilitates identification of unknown targets.

### SUMMARY

A target monitoring device according to one aspect of the disclosure includes processing circuitry configured to: sequentially acquire an image including a marine view captured by a camera during a panning operation; detect a target included in the image; determine whether or not the detected target is identical to a target registered in a database in which target data of a target detected by a target detection unit different from the camera is registered; and stop the panning operation of the camera with the detected target included in an angle of view, when the detected target is not the target registered in the database. As a result, it facilitates identification of unknown targets.

Moreover, a target monitoring method according to another aspect of the disclosure includes: acquiring an image including a marine view captured by a camera during a panning operation; detecting a target included in the image; determining whether or not the detected target is identical to a target registered in a database in which target data of a target detected by a target detection unit different from the camera is registered; and stopping the panning operation of the camera with the detected target included in an angle of view, when the detected target is not the target registered in the database. As a result, it facilitates identification of unknown targets.

Further, a non-transitory computer-readable recording medium, recording a control program according to another aspect of the disclosure causes a computer to: sequentially acquire an image including a marine view captured by a camera during a panning operation; detect a target included in the image; determine whether or not the detected target is identical to a target registered in a database in which target data of a target detected by a target detection unit different from the camera is registered; and stop the panning operation of the camera with the detected target included in an angle of view, when the detected target is not the target registered in the database. As a result, it facilitates identification of unknown targets.

### BRIEF DESCRIPTION OF DRAWINGS

The illustrated embodiments of the subject matter will be best understood by reference to the drawings, wherein like parts are designated by like numerals throughout. The following description is intended only by way of example, and simply illustrates certain selected embodiments of devices, systems, and processes that are consistent with the subject matter as claimed herein.

FIG. 1 is a diagram showing a configuration example of a target monitoring system.

FIG. 2 is a diagram showing a configuration example of a target monitoring device.

FIG. 3 is a diagram showing an example of an integration management database.

FIG. 4 is a diagram showing an example of an image captured by a camera.

FIG. 5 is a diagram showing an example of a camera panning operation.

FIG. 6 is a diagram showing an example of a camera panning operation.

FIG. 7 is a diagram showing an example of a camera panning operation.

FIG. 8 is a diagram showing an example of a camera panning operation.

FIG. 9 is a diagram showing a procedure example of a target monitoring method.

### DESCRIPTION OF EMBODIMENTS

A target monitoring device according to one aspect of the disclosure includes processing circuitry configured to: sequentially acquire an image including a marine view captured by a camera during a panning operation; detect a target included in the image; determine whether or not the detected target is identical to a target registered in a database in which target data of a target detected by a target detection unit different from the camera is registered; and stop the panning operation of the camera with the detected target included in an angle of view, when the detected target is not the target registered in the database. As a result, it facilitates identification of unknown targets.

In the above aspect, the camera control unit may continue the panning operation of the camera when the detected target is identical to the target registered in the database. As a result, it is possible to continue monitoring in panning operation.

In the above aspect, the image recognition unit may generate target data of the detected target from the image acquired while the panning operation is stopped, and register it in the database. As a result, it is possible to generate target data from an image acquired while the panning operation is stopped.

In the above aspect, the camera control unit may cause the camera to zoom and capture the detected target while the panning operation is stopped. As a result, it is possible to generated target data from the image captured by zooming.

In the above aspect, the camera control unit may cause the camera to resume the panning operation when a particular period of time has elapsed after the panning operation is stopped. As a result, it is possible to resume panning operation when a particular period of time has elapsed.

In the above aspect, the target data of a target detected by at least one of a camera different from the camera, a radar, and an Automatic Identification System (AIS) may be registered in the database. As a result, it is possible to suppress detection omission of a target by at least one of a camera, a radar, and an AIS.

Moreover, a target monitoring method according to another aspect of the disclosure includes: acquiring an image including a marine view captured by a camera during a panning operation; detecting a target included in the image; determining whether or not the detected target is identical to a target registered in a database in which target data of a target detected by a target detection unit different from the camera is registered; and stopping the panning operation of the camera with the detected target included in an angle of view, when the detected target is not the target registered in the database. As a result, it facilitates identification of unknown targets.

Further, a non-transitory computer-readable recording medium, recording a control program according to another aspect of the disclosure causes a computer to: sequentially acquire an image including a marine view captured by a camera during a panning operation; detect a target included in the image; determine whether or not the detected target is identical to a target registered in a database in which target data of a target detected by a target detection unit different from the camera is registered; and stop the panning operation of the camera with the detected target included in an angle of view, when the detected target is not the target registered in the database. As a result, it facilitates identification of unknown targets.

Embodiments of the disclosure will be described below with reference to the drawings.

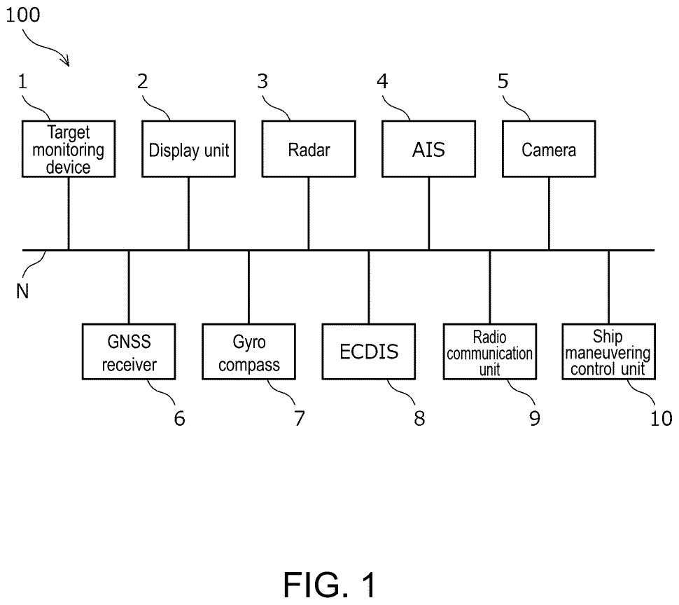

FIG. 1 is a block diagram showing a configuration example of a target monitoring system 100. The target monitoring system 100 is a system mounted on a ship. In the following description, a ship mounted with the target monitoring system 100 will be referred to as “own ship”, and the other ships will be referred to as “another ship”.

The target monitoring system 100 includes a target monitoring device 1, a display unit 2, a radar 3, an AIS 4, a camera 5, a GNSS receiver 6, a gyro compass 7, an ECDIS 8, a radio communication unit 9, and a ship maneuvering control unit 10. These devices are connected to a network N such as a LAN, and are capable of mutual network communication.

The target monitoring device 1 is a computer including a CPU, RAM, ROM, nonvolatile memory, input/output interface, and the like. The CPU of the target monitoring device 1 executes information processing according to a program loaded into the RAM from the ROM or nonvolatile memory.

The program may be supplied via an information storage medium such as an optical disk or a memory card, or may be supplied via a communication network such as the Internet or a LAN.

The display unit 2 displays a display image generated by the target monitoring device 1. The display unit 2 also displays a radar image, a camera image, an electronic chart, and the like.

The display unit 2 is, for example, a display device with a touch sensor, a so-called touch panel. The touch sensor detects a position indicated on the screen by a user's finger or the like, but not limited thereto. An indicated position may also be input using a trackball or the like.

The radar 3 emits radio waves around the own ship, receives the reflected waves, and generates echo data based on the received signals. Further, the radar 3 identifies a target from the echo data and generates a TT (Target Tracking) data representing the position and speed of the target. The TT data may also be generated in the target monitoring device 1.

The AIS (Automatic Identification System) 4 receives AIS data from another ship around the own ship or from land-based control. The disclosure is not limited to AIS, VDES (VHF Data Exchange System) may also be configured. The AIS data includes identification code, ship name, position, course, ship speed, ship type, hull length, destination, and the like of another ship.

The camera 5 is a digital camera that captures images of the outside from the own ship and generates image data. The camera 5 is installed, for example, on the bridge of the own ship, facing the bow azimuth. The camera 5 is a camera with pan, tilt, and zoom functions, a so-called PTZ camera.

Further, the camera 5 may include an image recognition unit that estimates the position and type of a target such as another ship included in a captured image using an object detection model. The image recognition unit may be realized not only in the camera 5, and also in other devices such as the target monitoring device 1.

The GNSS receiver 6 detects the position of the own ship based on radio waves received from GNSS (Global Navigation Satellite System). The gyro compass 7 detects the bow azimuth of the own ship. The disclosure is not limited to the gyro compass, a GPS compass may also be configured.

The ECDIS (Electronic Chart Display and Information System) 8 acquires the position of the own ship from the GNSS receiver 6 and displays the position of the own ship on the electronic chart. The ECDIS 8 also displays the planned route of the own ship on the electronic chart. The disclosure is not limited to ECDIS, a GNSS plotter may also be configured.

The radio communication unit 9 includes various types of radio equipment for communicating with another ship or land-based control, such as radio equipment for ultra-high frequency, very high frequency band, medium/high frequency band, and high frequency band.

The ship maneuvering control unit 10 is a control device for realizing automatic ship maneuvering, and controls the steering gear of the own ship. Further, the ship maneuvering control unit 10 may control the engine of the own ship.

In the embodiment, the target monitoring device 1 is an independent device, but is not limited thereto and may be integrated with other devices such as the ECDIS 8. That is, the functional units of the target monitoring device 1 may be realized by other devices.

In the embodiment, the target monitoring device 1 is mounted on the own ship and is configured to monitor a target such as another ship around the own ship, but its use is not limited thereto. For example, the target monitoring device 1 may be installed in a land-based control and configured to monitor ships in a controlled sea area.

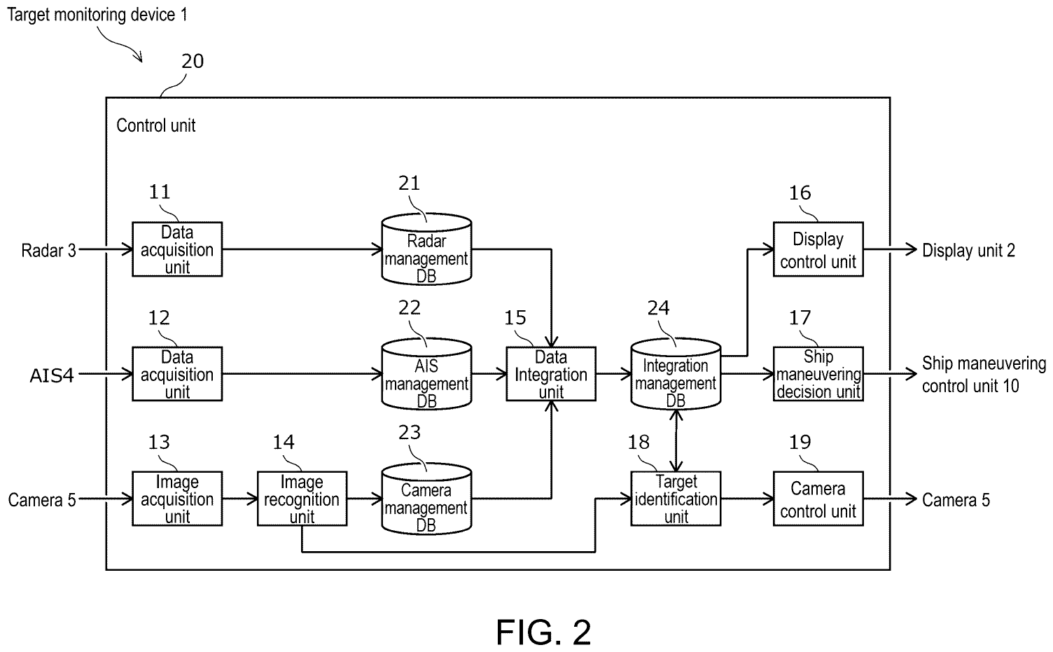

FIG. 2 is a diagram showing a configuration example of the target monitoring device 1. A control unit 20 of the target monitoring device 1 includes a data acquisition unit 11, a data acquisition unit 12, an image acquisition unit 13, an image recognition unit 14, a data integration unit 15, a display control unit 16, a ship maneuvering decision unit 17, a target identification unit 18, and a camera control unit 19. These functional units are realized by the control unit 20 executing information processing according to the program.

The control unit 20 of the target monitoring device 1 further includes a radar management DB (database) 21, an AIS management DB 22, a camera management DB 23, and an integration management DB 24. These storage units are provided in the memory of the control unit 20.

The data acquisition unit 11 sequentially acquires the TT data generated by the radar 3 as target data, and registers it in a radar management DB 21.

The target data registered in the radar management DB 21 includes the position, ship speed, course, etc. of a target such as another ship detected by the radar 3. The target data registered in the radar management DB 21 may further include the track of the target, the elapsed time since detection, the size of an echo image, the signal strength of the reflected waves, and the like.

The data acquisition unit 12 acquires the AIS data received by the AIS 4 as target data, and registers it in the AIS management DB 22.

The target data registered in the AIS management DB 22 includes the position, ship speed, course, etc. of another ship detected by the AIS 4. The target data registered in the AIS management DB 22 may further include the type, ship name, hull length, hull width, destination, etc. of another ship.

The image acquisition unit 13 acquires an image including a target such as another ship captured by the camera 5. The image acquisition unit 13 sequentially acquires a time-series image from the camera 5 and sequentially provides it to the image recognition unit 14. The time-series image is, for example, a still image (frame) included in moving image data.

The image recognition unit 14 performs image recognition on the image acquired by the image acquisition unit 13, generates target data of the target recognized from the image, and registers it in the camera management DB 23. Details of the image recognition unit 14 will be described later.

The target data registered in the camera management DB 23 includes the position, ship speed, course, etc. of a target such as another ship calculated by the image recognition unit 14. The target data registered in the camera management DB 23 may further include the size of the target, the type of the target, the elapsed time from detection, and the like.

Since the position of the target detected by the radar 3 and the position of the target recognized from the image captured by the camera 5 are relative positions with respect to the own ship, they are converted into absolute positions that also include azimuth information using the position and bow azimuth of the own ship detected by the GNSS receiver 6. Moreover, the bow azimuth may be acquired from a gyro sensor or the like instead of the GNSS receiver.

Moreover, the target detected by the radar 3 and the target recognized from the image captured by the camera 5 are mainly ships, but may also include, for example, buoys.

The target data registered in the camera management DB 23 may be not only the target data of the target recognized from an image captured by the camera 5 but also the target data of the target recognized from an image captured by a PZT camera of the same type as the camera 5 but installed separately, a fixed-point camera, a 360-degree camera, or an infrared camera which is different in type from the camera 5.

The data integration unit 15 registers the target data registered in the radar management DB 21, the AIS management DB 22, and the camera management DB 23 into the integration management DB 24 for managing these databases cross-sectionally.

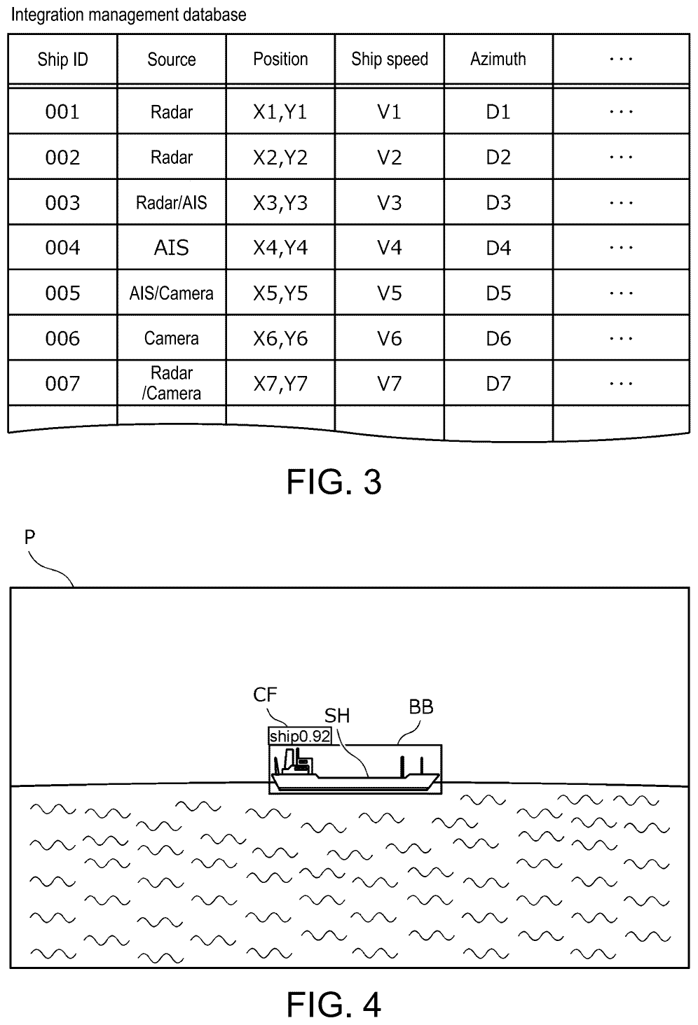

As shown in FIG. 3, the target data registered in the integration management DB 24 includes the position, ship speed, course, etc. of a target such as another ship. “Source” indicates the source of the target data, i.e. it indicates which of the radar 3, the AIS 4, and the camera 5 detected the target.

When the position of a target registered in one of the radar management DB 21, the AIS management DB 22, and the camera management DB 23 is identical or approximate to the position of a target registered in the other one, the data integration unit 15 integrates their target data. Moreover, the accuracy of calculating the position of a target by a camera is often low; in that case, in addition to the position of the target or in place of the position of the target, at least one of the speed, course (azimuth), and size of the target may also be a condition for integration.

The display control unit 16 generates a display image including an object representing the target based on the target data registered in the integration management DB 24 and outputs it to the display unit 2. The display image is, for example, a radar image, an electronic chart, or a composite image thereof, and the object representing the target is arranged at a position within the image corresponding to the actual position of the target.

The ship maneuvering decision unit 17 makes a ship maneuvering decision based on the target data registered in the integration management DB 24, and when it is decided that there is a need avoid the target, causes the ship maneuvering control unit 10 to perform avoidance maneuvering. Specifically, the ship maneuvering control unit 10 calculates an avoidance route for avoiding a target using an avoidance maneuvering algorithm, and controls the steering gear, engine, etc. such that the own ship follows the avoidance route.

The image acquisition unit 13 and the image recognition unit 14 will be described again. In the embodiment, the target is monitored while the camera 5 is panned. The image acquisition unit 13 sequentially acquires an image including a marine view captured by the camera 5 during panning operation.

The image recognition unit 14 detects a target included in the image acquired by the data acquisition unit 13. Specifically, the image recognition unit 14 calculates the region of the target included in the image, the type of the target, and the reliability of estimation using a learned model generated in advance by machine learning. The type of target is, for example, the type of ship such as a tanker or a fishing boat, but the disclosure is not limited thereto. The image recognition unit 14 may also recognize the region, type, etc. of the target included in the image by a rule base.

The learned model is, for example, an object detection model such as SSD (Single Shot MultiBox Detector) or YOLO (You Only Look Once), and detects a bounding box surrounding a target included in the image as a target region, but the disclosure is not limited thereto. The learned model may also be a region segmentation model such as Semantic Segmentation or Instance Segmentation.

As shown in FIG. 4, another ship SH included in an image P captured by the camera 5 is surrounded by a rectangular bounding box BB. A label CF describing the type of target and the reliability of estimation is added to the bounding box BB.

The target identification unit 18 determines whether or not the target detected by the image recognition unit 14 is identical to the target registered in the integration management DB 24. Whether or not the targets are identical is determined by whether or not the positions of the targets are identical or approximate. Moreover, the accuracy of calculating the position of a target by a camera is often low; in that case, in addition to the position of the target or in place of the position of the target, at least one of the speed, course (azimuth), and size of the target may also be a condition for integration.

In the embodiment, whether or not the targets are identical is determined by referring to the integration management DB 24 where the target data detected by the radar 3, the AIS 4, or the camera 5 is registered, but the database to be referred to is not limited thereto.

For example, whether or not the targets are identical may be determined by referring to the radar management DB 21 or the AIS management DB 22, where target data detected by the radar 3 or the AIS 4, which are target detection units different from the camera 5, is registered.

The camera control unit 19 controls the panning operation, tilting operation, or zooming operation of the camera 5. In the embodiment, the camera control unit 19 causes the camera 5 to repeatedly perform the panning operation when monitoring a target.

When the target detected by the image recognition unit 14 is identical to the target registered in the integration management DB 24, the camera control unit 19 continues the panning operation of the camera 5. When the detected target is not a target registered in the integration management DB 24, the camera control unit 19 stops the panning operation of the camera 5 with the detected target included in an angle of view.

The image recognition unit 14 performs image recognition on the image acquired while the panning operation of the camera 5 is stopped, generates target data of the detected target, and registers it in the camera management DB 23. The registered target data is further registered in the integration management DB 24. As a result, the target data is registered while the panning operation of the camera 5 is stopped and detection omission can be prevented.

The camera control unit 19 causes the camera 5 to zoom and capture the target while the panning operation of the camera 5 is stopped. The image recognition unit 14 performs image recognition on the image captured by zooming, generates target data of the detected target, and registers it in the camera management DB 23. As a result, target data with higher accuracy can be generated.

The camera control unit 19 causes the camera 5 to resume panning operation when a particular period of time (for example, several seconds or tens of seconds) has elapsed after the panning operation of the camera 5 is stopped.

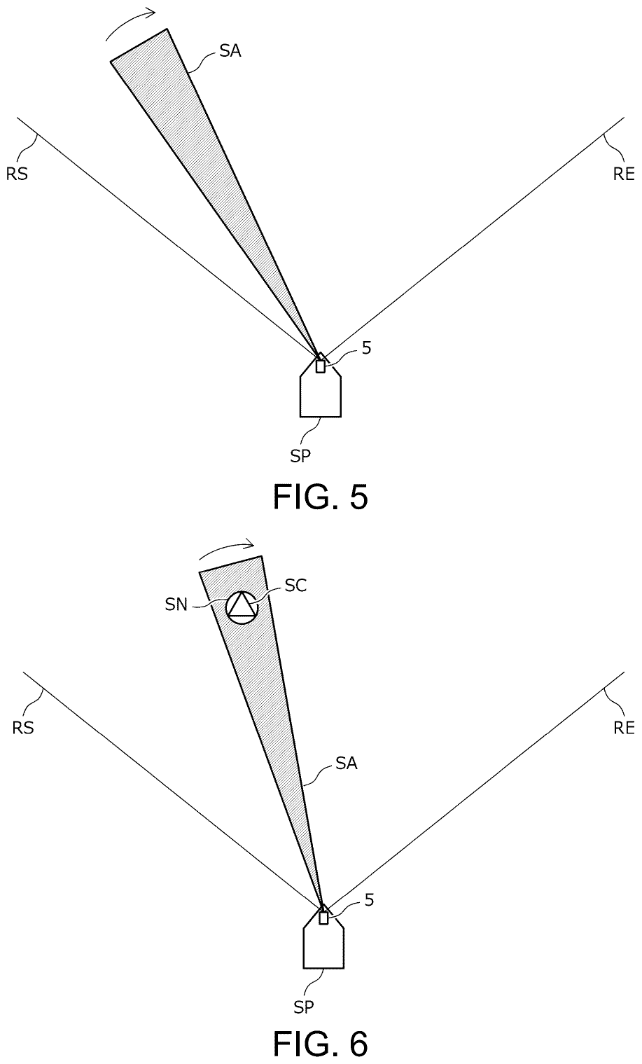

FIGS. 5 to 8 are diagrams for illustrating the panning operation of the camera 5. SA represents an angle of view of the camera 5. RS represents a start angle of the panning operation, and RE represents an end angle of the panning operation. The angle of view SA of the camera 5 moves from the start angle RS to the end angle RE.

Further, SC represents a target recognized from the image of the camera 5 (hereinafter referred to as an image-recognized target SC). SN represents a target registered in the integration management DB 24 (hereinafter referred to as a DB-registered target SN).

FIG. 5 shows a situation where no image-recognized target SC exists within the angle of view SA of the camera 5. At this time, the camera control unit 19 updates the azimuth of the camera 5, that is, continues the panning operation.

FIG. 6 shows a situation where an image-recognized target SC exists within the angle of view SA of the camera 5, and an identical DB-registered target SN also exists. This is a situation where there is no detection omission (overlook). At this time, the camera control unit 19 updates the azimuth of the camera 5.

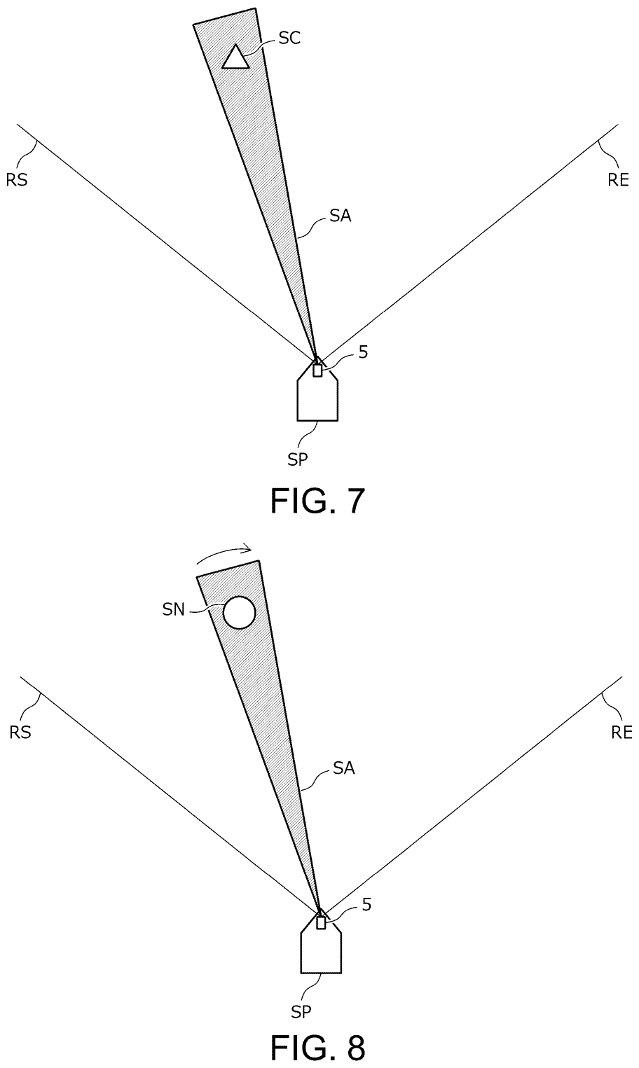

FIG. 7 shows a situation where an image-recognized target SC exists within the angle of view SA of the camera 5, but no identical DB-registered target SN exists. This is a situation where there is a detection omission. At this time, the camera control unit 19 temporarily stops updating the azimuth of the camera 5, that is, temporarily stops the panning operation. As a result, the camera 5 enters a state in which the image-recognized target SC remains included in the angle of view SA (target-locked state).

The image recognition unit 14 performs image recognition on the image captured in the target-locked state, generates target data of the detected target, and registers it in the camera management DB 23. The registered target data is further registered in the integration management DB 24. This results in the same situation as in FIG. 6 above, in which the image-recognized target SC exists within the angle of view SA of the camera 5, and an identical DB-registered target SN also exists.

FIG. 8 shows a situation where there is no image-recognized target SC existing within the angle of view SA of the camera 5, but a DB-registered target SN exists. This is also a situation where there is no detection omission. At this time, the camera control unit 19 updates the azimuth of the camera 5.

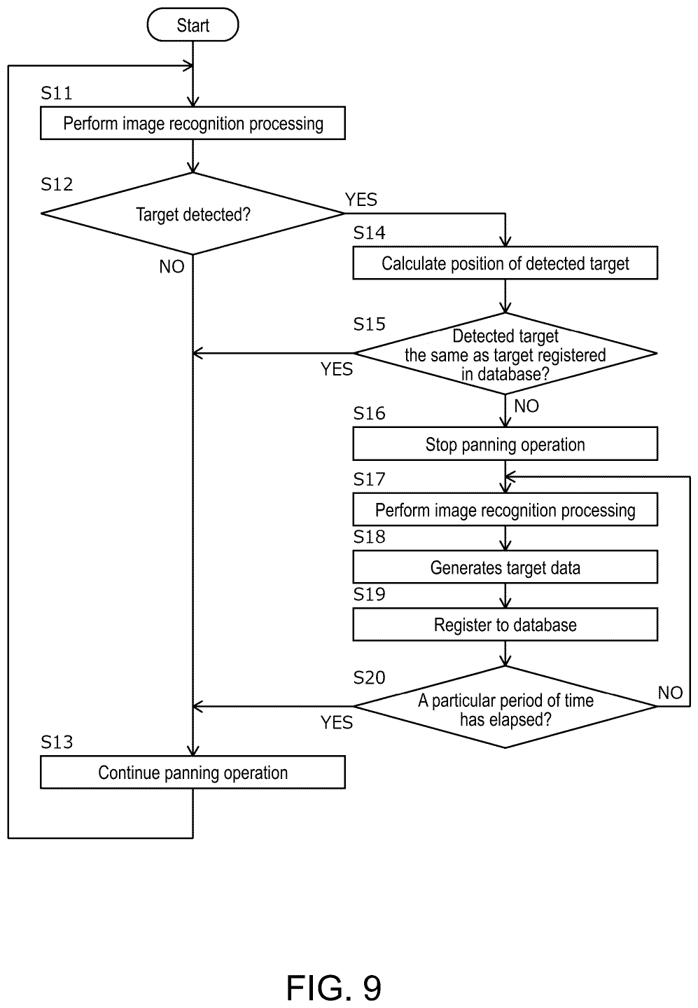

FIG. 9 is a diagram showing a procedure example of a target monitoring method realized in the target monitoring system 100. The diagram mainly shows the processing of monitoring a target while the camera 5 is performing panning operation. The target monitoring device 1 executes the processing shown in the diagram according to the program.

When an image captured is acquired by the camera 5 during panning operation, the target monitoring device 1 performs image recognition processing (S11, processing as the image recognition unit 14).

When no target is detected by the image recognition processing (S12: NO), the target monitoring device 1 continues the panning operation of the camera 5 (S13, the situation shown in FIG. 5 above).

On the other hand, when a target is detected by the image recognition processing (S12: YES), the target monitoring device 1 calculates the position of the detected target (S14). The position of the target is calculated based on the position of the target in the image, the orientation of the camera 5, and the position of the own ship.

Next, the target monitoring device 1 determines whether or not the detected target is identical to the target registered in the integration management DB 24 (S15, processing as the target identification unit 18). Whether or not the targets are identical is determined by whether or not the positions of the targets are identical or approximate.

When the target detected by the image recognition processing is identical to the target registered in the integration management DB 24 (S15: YES), the target monitoring device 1 continues the panning operation of the camera 5 (S13, processing as the camera control unit 19, the situation shown in FIG. 6 above).

On the other hand, when the target detected by the image recognition processing is not identical to the target registered in the integration management DB 24 (S15: NO), the target monitoring device 1 stops the panning operation of the camera 5 (S16, processing as the camera control unit 19, the situation shown in FIG. 7 above).

Next, the target monitoring device 1 performs image recognition on the image acquired while the panning operation of the camera 5 is stopped, generates target data of the detected target, and registers it in the camera management DB 23 (S17-S19, processing as the image recognition unit 14).

When a particular period of time has elapsed after the panning operation of the camera 5 is stopped (S20: YES), the target monitoring device 1 causes the camera 5 to resume the panning operation (S13, processing as the camera control unit 19, the situation shown in FIG. 6 above).

The target monitoring device 1 repeats the above processings S11 to S20 while the camera 5 is performing panning operation.

According to the embodiment described above, it is possible to facilitate identification of targets detected while the camera 5 is performing panning operation and unknown by the integration management DB 24. Further, it is possible to generate target data from an image acquired while the panning operation is stopped and register it in the integration management DB 24.

Although the embodiments of the disclosure have been described above, the disclosure is not limited to the embodiments described above, and it goes without saying that various modifications can be made by those skilled in the art.

It is to be understood that not necessarily all objects or advantages may be achieved in accordance with any particular embodiment described herein. Thus, for example, those skilled in the art will recognize that certain embodiments may be configured to operate in a manner that achieves or optimizes one advantage or group of advantages as taught herein without necessarily achieving other objects or advantages as may be taught or suggested herein.

All of the processes described herein may be embodied in, and fully automated via, software code modules executed by a computing system that includes one or more computers or processors. The code modules may be stored in any type of non-transitory computer-readable medium or other computer storage device. Some or all the methods may be embodied in specialized computer hardware.

Many other variations than those described herein will be apparent from this disclosure. For example, depending on the embodiment, certain acts, events, or functions of any of the algorithms described herein can be performed in a different sequence, can be added, merged, or left out altogether (e.g., not all described acts or events are necessary for the practice of the algorithms). Moreover, in certain embodiments, acts or events can be performed concurrently, e.g., through multi-threaded processing, interrupt processing, or multiple processors or processor cores or on other parallel architectures, rather than sequentially. In addition, different tasks or processes can be performed by different machines and/or computing systems that can function together.

The various illustrative logical blocks and modules described in connection with the embodiments disclosed herein can be implemented or performed by a machine, such as a processor. A processor can be a microprocessor, but in the alternative, the processor can be a controller, microcontroller, or state machine, combinations of the same, or the like. A processor can include electrical circuitry configured to process computer-executable instructions. In another embodiment, a processor includes an application specific integrated circuit (ASIC), a field programmable gate array (FPGA) or other programmable device that performs logic operations without processing computer-executable instructions. A processor can also be implemented as a combination of computing devices, e.g., a combination of a digital signal processor (DSP) and a microprocessor, a plurality of microprocessors, one or more microprocessors in conjunction with a DSP core, or any other such configuration. Although described herein primarily with respect to digital technology, a processor may also include primarily analog components. For example, some or all of the signal processing algorithms described herein may be implemented in analog circuitry or mixed analog and digital circuitry. A computing environment can include any type of computer system, including, but not limited to, a computer system based on a microprocessor, a mainframe computer, a digital signal processor, a portable computing device, a device controller, or a computational engine within an appliance, to name a few.

Conditional language such as, among others, “can,” “could,” “might” or “may,” unless specifically stated otherwise, are otherwise understood within the context as used in general to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

Disjunctive language such as the phrase “at least one of X, Y, or Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Any process descriptions, elements or blocks in the flow diagrams described herein and/or depicted in the attached figures should be understood as potentially representing modules, segments, or portions of code which include one or more executable instructions for implementing specific logical functions or elements in the process. Alternate implementations are included within the scope of the embodiments described herein in which elements or functions may be deleted, executed out of order from that shown, or discussed, including substantially concurrently or in reverse order, depending on the functionality involved as would be understood by those skilled in the art.

Unless otherwise explicitly stated, articles such as “a” or “an” should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B and C” can include a first processor configured to carry out recitation A working in conjunction with a second processor configured to carry out recitations B and C. The same holds true for the use of definite articles used to introduce embodiment recitations. In addition, even if a specific number of an introduced embodiment recitation is explicitly recited, those skilled in the art will recognize that such recitation should typically be interpreted to mean at least the recited number (e.g., the bare recitation of “two recitations,” without other modifiers, typically means at least two recitations, or two or more recitations).

It will be understood by those within the art that, in general, terms used herein, are generally intended as “open” terms (e.g., the term “including” should be interpreted as “including but not limited to,” the term “having” should be interpreted as “having at least,” the term “includes” should be interpreted as “includes but is not limited to,” etc.).

For expository purposes, the term “horizontal” as used herein is defined as a plane parallel to the plane or surface of the floor of the area in which the system being described is used or the method being described is performed, regardless of its orientation. The term “floor” can be interchanged with the term “ground” or “water surface”. The term “vertical” refers to a direction perpendicular to the horizontal as just defined. Terms such as “above,” “below,” “bottom,” “top,” “side,” “higher,” “lower,” “upper,” “over,” and “under,” are defined with respect to the horizontal plane.

As used herein, the terms “attached,” “connected,” “mated,” and other such relational terms should be construed, unless otherwise noted, to include removable, moveable, fixed, adjustable, and/or releasable connections or attachments. The connections/attachments can include direct connections and/or connections having intermediate structure between the two components discussed.

Numbers preceded by a term such as “approximately”, “about”, and “substantially” as used herein include the recited numbers, and also represent an amount close to the stated amount that still performs a desired function or achieves a desired result. For example, the terms “approximately”, “about”, and “substantially” may refer to an amount that is within less than 10% of the stated amount. Features of embodiments disclosed herein preceded by a term such as “approximately”, “about”, and “substantially” as used herein represent the feature with some variability that still performs a desired function or achieves a desired result for that feature. It should be emphasized that many variations and modifications may be made to the above-described embodiments, the elements of which are to be understood as being among other acceptable examples. All such modifications and variations are intended to be included herein within the scope of this disclosure and protected by the following claims.

What is claimed is:

1. A target monitoring device, comprising:
processing circuitry configured to:
sequentially acquire an image including a marine view captured by a camera during a panning operation;
detect a target included in the image;
determine whether or not the detected target is identical to a target registered in a database in which target data of a target detected by a target detection unit different from the camera is registered; and
stop the panning operation of the camera with the detected target included in an angle of view, when the detected target is not the target registered in the database.

2. The target monitoring device according to claim 1,
wherein the camera control unit continues the panning operation of the camera when the detected target is identical to the target registered in the database.

3. The target monitoring device according to claim 1,
wherein the image recognition unit generates target data of the detected target from the image acquired while the panning operation is stopped, and registers it in the database.

4. The target monitoring device according to claim 2,
wherein the image recognition unit generates target data of the detected target from the image acquired while the panning operation is stopped, and registers it in the database.

5. The target monitoring device according to claim 1,
wherein the camera control unit causes the camera to zoom and capture the detected target while the panning operation is stopped.

6. The target monitoring device according to claim 2,
wherein the camera control unit causes the camera to zoom and capture the detected target while the panning operation is stopped.

7. The target monitoring device according to claim 3,
wherein the camera control unit causes the camera to zoom and capture the detected target while the panning operation is stopped.

8. The target monitoring device according to claim 1,
wherein the camera control unit causes the camera to resume the panning operation when a particular period of time has elapsed after the panning operation is stopped.

9. The target monitoring device according to claim 2,
wherein the camera control unit causes the camera to resume the panning operation when a particular period of time has elapsed after the panning operation is stopped.

10. The target monitoring device according to claim 3,
wherein the camera control unit causes the camera to resume the panning operation when a particular period of time has elapsed after the panning operation is stopped.

11. The target monitoring device according to claim 4,
wherein the camera control unit causes the camera to resume the panning operation when a particular period of time has elapsed after the panning operation is stopped.

12. The target monitoring device according to claim 1,
wherein target data of a target detected by at least one of a camera different from the camera, a radar, and an AIS (Automatic Identification System) is registered in the database.

13. The target monitoring device according to claim 2,
wherein target data of a target detected by at least one of a camera different from the camera, a radar, and an AIS (Automatic Identification System) is registered in the database.

14. The target monitoring device according to claim 3,
wherein target data of a target detected by at least one of a camera different from the camera, a radar, and an AIS (Automatic Identification System) is registered in the database.

15. The target monitoring device according to claim 4,
wherein target data of a target detected by at least one of a camera different from the camera, a radar, and an AIS (Automatic Identification System) is registered in the database.

16. The target monitoring device according to claim 5,
wherein target data of a target detected by at least one of a camera different from the camera, a radar, and an AIS (Automatic Identification System) is registered in the database.

17. A target monitoring method, comprising:
acquiring an image including a marine view captured by a camera during a panning operation;
detecting a target included in the image;
determining whether or not the detected target is identical to a target registered in a database in which target data of a target detected by a target detection unit different from the camera is registered; and
stopping the panning operation of the camera with the detected target included in an angle of view, when the detected target is not the target registered in the database.

18. A non-transitory computer-readable recording medium, recording a control program that causes a computer to:
sequentially acquire an image including a marine view captured by a camera during a panning operation;
detect a target included in the image;
determine whether or not the detected target is identical to a target registered in a database in which target data of a target detected by a target detection unit different from the camera is registered; and
stop the panning operation of the camera with the detected target included in an angle of view, when the detected target is not the target registered in the database.
